(19) United States
(12) Patent Application Publication
(10) Pub. No.: US 2025/0001442 A1
(43) Pub. Date: Jan. 2, 2025

(54) ADAPTER, FLUID DISPENSING DEVICE HAVING SAID ADAPTER, AND ASSEMBLY METHOD

(71) Applicant: Aero Pump GmbH, Hochheim/Main (DE)

(72) Inventors: Sebastian ROTHER, Mainz (DE); Milena Angelika MARSZALEK, Mainz (DE)

(73) Assignee: Aero Pump GmbH, Hochheim/Main (DE)

(21) Appl. No.: 18/757,901

(22) Filed: Jun. 28, 2024

(30) Foreign Application Priority Data
Jun. 30, 2023 (EP) 23182559.7

(51) Int. Cl. B05B 11/10

(52) U.S. Cl. CPC B05B 11/1047

(57) ABSTRACT

Adapter, fluid dispensing device, and method. The adapter, for connecting a second sleeve of an upper part and a first sleeve of a lower part of a fluid dispensing device, includes a ring-shaped base body with: a longitudinal axis; an inner surface, which encloses a through opening for accommodating the first sleeve and includes an inner locking structure; and an outer surface, which is insertable into an opening of the second sleeve and includes an outer locking structure. At least one of the locking structures is designed such that when the adapter is connected to one of the first or second sleeve, resistance to a relative movement of the adapter to the one of the first or second sleeve in a first direction along the longitudinal axis is greater than in a second direction opposed to the first direction.

### CROSS-REFERENCE TO RELATED APPLICATION

This application claims priority under 35 U.S.C. § 119(a) to Europe Application No. 23182559.7 filed Jun. 30, 2023, the disclosure of which is expressly incorporated by reference herein in its entirety.

### BACKGROUND

### 1. Field of the Invention

The invention relates to an adapter for use in a fluid dispensing device such as a manually-operated pump, in particular a spray pump or drip pump, for discharging liquids, as well as a fluid dispensing device having such an adapter and a method for assembling the fluid dispensing device.

### 2. Discussion of Background Information

Pump systems of this type are often manufactured based on a modular system in which individual parts are inserted into one another and connected to one another with positive fits or press fits. Normally, two large sub-assemblies are assembled, the upper and lower part, which are paired, that is, assembled to one another, in a final assembly step.

From DE 10 2013 218 802 B4 and DE 10 2015 104 646 B3, fluid dispensing devices of this type are respectively known which comprise an upper part and a lower part that are connected to one another during assembly. In this case, the upper part comprises a head with a sleeve, and the lower part is provided with a sleeve that is also referred to as a cone. These two sleeves, which together form a fluid channel, are inserted into one another during assembly of the fluid dispensing device. A press fit and/or a form fit then securely holds the two sleeves in one another when the fluid device is in operation.

The use of fluid dispensing devices to discharge unpreserved products is generally known. Within the entire system, these products are protected from the contaminated atmosphere by various safety barriers. It is important that pumps of this type are always used correctly and are not disassembled, so that the protection is ensured at all times and the protective barriers are not circumvented. Therefore, the press fits of the assembled parts are, to the greatest possible extent, chosen such that a user can detach the upper part from the lower part only with difficulty. Despite this, in known fluid dispensing devices it is possible in some cases to separate the lower part from the upper part and to reconnect said parts afterwards. Once these two parts of the pump have been separated from one another, however, a contamination protection is no longer ensured. In addition, after a reconnection, it is not possible to determine that both parts were separated beforehand or that the product that is to be discharged may possibly be contaminated. Accordingly, as a result of such tampering with the pump, a contamination is possible without it being possible to track how said contamination arose.

### SUMMARY

Embodiments seek to prevent to the greatest possible extent a tampering by disassembly of the upper part from the lower part in fluid dispensing devices and, in the event of such a tampering, to render more difficult continued use of the fluid dispensing device. In other words, either the disassembly is to be rendered impossible, or a disassembly is to be recognizable after the fact, so that the tempering can be clearly proven.

Embodiments are based on the concept that an adapter is provided which is suitable for securely connecting the upper part and the lower part of a fluid dispensing device. According to embodiments, an adapter of this type for connecting a sleeve of an upper part and a sleeve of a lower part of a fluid dispensing device can include a ring-shaped base body with a longitudinal axis. An inner surface of the adapter thereby encloses a through opening for accommodating a sleeve, for example of the lower part, and is provided with an inner locking structure. Furthermore, the adapter is provided with an outer surface that can be inserted into an opening of a sleeve, for example of the upper part, which outer surface has an outer locking structure. At least one of the locking structures, in one exemplary embodiment even both locking structures, is/are thereby designed such that when the adapter is connected to the respective sleeve, the resistance to a relative movement of the adapter to the sleeve in one direction along the longitudinal axis is greater than in a direction opposed to said direction. In particular, at least one of the locking structures is thereby designed such that the resistance to a relative movement of the adapter to the sleeve in a disassembly direction along the longitudinal axis is greater than in an assembly direction opposed to said disassembly direction. In other words, it is easier to connect the adapter to the respective sleeve, that is, to fit the adapter onto a sleeve, for example the sleeve of the lower part, or to insert the adapter into a sleeve, for example the sleeve of the upper part, than to separate the adapter from the respective sleeve, that is, to pull the adapter off a sleeve or to pull the adapter out of a sleeve.

If the inner locking structure is designed such that, in an assembled state, that is, when the sleeve of the lower part has been accommodated in the adapter, the resistance to the displacement of the adapter on the sleeve of the lower part in a first (disassembly) direction along the longitudinal axis is greater than in a second (assembly) direction opposed to the first direction, the pulling-off of the adapter from the sleeve is rendered more difficult due to the comparatively high disassembly force that is necessary therefor. Since the adapter can thus be relatively firmly connected to the sleeve of the lower part, it is possible, through a corresponding design of the interface with the upper part, to achieve that, in the event of a tampering attempt, said interface fails before the connection between the adapter and lower part is released. On the other hand, due to the comparatively lower resistance, the adapter can be moved easily on the sleeve of the lower part if an attempt were made to once again connect the upper and lower part. This position of the adapter on the sleeve of the lower part, which position is altered relative to the original assembly position during the attempt at reassembly, can render a reassembly impossible and/or can render the further use of the pump impossible. Thus, with an adapter according to the invention, it is possible to both obtain a tamper protection and also to furnish proof that a system has been tampered with.

In an adapter according to the invention, the inner locking structure can comprise at least one projection, protruding radially inwards from the inner surface, having an insertion bevel. Preferably, the insertion bevel is designed such that it decreases the inner diameter of the adapter in the first direction in sections and forms an undercut having an inner diameter that is increased in sections. The insertion bevel is thereby preferably arranged such that the adapter can be slid onto the sleeve of the lower part with an (assembly) force that is less than the force necessary for disassembly. In this design, the inner locking structure can become wedged in the sleeve of the lower part in the disassembly direction, whereas assembly is still easily possible in the assembly direction due to the insertion bevel. Preferably, the inner locking mechanism embeds itself deep into what is referred to as the cone, that is, the sleeve of the lower part, whereby the connection is so strong that it can no longer be separated even using pliers.

Both the inner locking structure and the outer locking structure can be formed by a single, for example circumferential, projection or by multiple, for example wedge-shaped, projections. If multiple projections are provided, they can be arranged offset from one another in a circumferential direction and/or in the direction of the longitudinal axis. The resistance to relative movements of the adapter to a sleeve can additionally be set in a defined manner using further constructive measures, for example using different surface roughnesses and/or using additional projections, for example in the form of one or more ribs that extend parallel to the longitudinal axis, or in the form of one or more beads extending in a circumferential direction.

If the inner surface comprises a first region having a first inner diameter and a second region having an inner diameter smaller relative to the first region, material of the sleeve of the lower part can, in an attempt to release the adapter from the lower part, be displaced or flake off into the first region, whereby the disassembly resistance becomes even greater. The two regions are thereby preferably separated from one another by the at least one projection of the inner locking structure.

According to a further exemplary embodiment, the outer surface of the adapter can be provided with an outer locking structure which is designed such that, when the adapter has been accommodated in the sleeve of the upper part, the resistance to the displacement of the adapter in the sleeve of the upper part in the first (assembly) direction along the longitudinal axis is smaller than in the second (disassembly) direction opposed to the first direction. Accordingly, disassembly is also rendered more difficult than assembly as a result. For this purpose, the outer locking structure can comprise at least one projection, protruding radially outwards from the outer surface, having an insertion bevel which increases the outer diameter of the adapter in the second direction in sections and forms an undercut with an outer diameter that is decreased in sections.

A particularly firm connection between the adapter and the sleeves of the pump can be obtained in that the adapter is composed of a material having a Shore D hardness (according to DIN EN ISO 868) of greater than 75, in particular between 80 and 90, for example a metal or a plastic. A preferred material for the adapter is, for example, polyoxymethylene (POM), which for example can have a Shore D hardness (according to DIN EN ISO 868) of 83.

In a fluid dispensing device according to the invention having an upper part, which comprises at least one sleeve with an inner sleeve diameter, and a lower part that can be connected thereto, which comprises at least one sleeve with an outer sleeve diameter, the sleeve of the upper part can be connected to the sleeve of the lower part by means of an adapter of the type named above, wherein the adapter is respectively connected to the sleeve of the upper part and the sleeve of the lower part in a form fit and/or by means of a press fit.

Preferably, the sleeve of the lower part can be composed of a material having a Shore D hardness (according to DIN EN ISO 868) of less than 75, in particular between 45 and 70. Suitable materials for the sleeve of the lower part include polypropylene (PP), 65 to less than 75, and polyethylene (PE), for example with a Shore D hardness (according to DIN EN ISO 868) of approximately 45 (for PE-LD) or 64 (for PE-HD).

If in the fluid dispensing device, the sleeve of the upper part includes a projection protruding radially inwards which, with the undercut of the outer locking mechanism, forms a snap-lock connection, the adapter and upper part can be connected in a defined and secure manner. At the same time, the force necessary for assembly can be set such that, after a tampering, the adapter moves on the sleeve of the lower part instead of the adapter sliding farther into the sleeve of the upper part.

Preferably, the sleeve of the upper part, the sleeve of the lower part, and the adapter are designed and matched to one another such that the assembly force F1, which is required for inserting the adapter into the sleeve of the upper part, is greater than the assembly force F2, which is required for fitting the adapter onto the sleeve of the lower part, and that the disassembly force F3, which is required for pulling the adapter out of the sleeve of the upper part, is less than the disassembly force F4, which is required for pulling the adapter off the sleeve of the lower part. Thus, as described above, it is possible to both obtain a tamper protection and also to furnish proof that a system has been tampered with.

A method according to the invention for assembling a fluid dispensing device of the type named above comprises the following steps: providing an upper part that comprises at least one sleeve with an inner sleeve diameter, a lower part that comprises at least one sleeve with an outer sleeve diameter, and an adapter; then inserting the adapter into the sleeve of the upper part; then inserting the sleeve of the lower part into the adapter. This assembly sequence ensures that, during the initial assembly, the adapter is not already moved into a position that, according to the invention, would indicate a tampering or would impede a full assembly or use of the pump.

The terms upper part and lower part of the fluid dispensing device are not to be understood as being limiting. The upper part can comprise a fluid outlet in the form of a nozzle or the like, and the lower part can be connected to a fluid container or comprise said container. In principle, however, the lower part can also comprise a fluid outlet in the form of a nozzle or the like, and the upper part can be connected to a fluid container or comprise said container. The fluid dispensing device is described herein in part using the example of a manually operable spray pump. However, the fluid dispensing device is not limited to a pump of this type. Instead, the adapter can also be used in other fluid dispensing devices.

Embodiments are directed to an adapter for connecting a second sleeve of an upper part and a first sleeve of a lower part of a fluid dispensing device. The adapter includes a ring-shaped base body with: a longitudinal axis; an inner surface, which encloses a through opening for accommodating the first sleeve and includes an inner locking structure; and an outer surface, which is insertable into an opening of the second sleeve and includes an outer locking structure. At least one of the locking structures is designed such that when the adapter is connected to one of the first or second sleeve, resistance to a relative movement of the adapter to the one of the first or second sleeve in a first direction along the longitudinal axis is greater than in a second direction opposed to the first direction.

In embodiments, the inner locking structure may include at least one projection, which may protrude radially inwards from the inner surface and may have an insertion bevel that decreases an inner diameter of the adapter in the first direction in sections and may form an undercut with an inner diameter that is increased in sections.

According to embodiments, the outer locking structure may include at least one projection, which can protrude radially outwards from the outer surface and can have an insertion bevel that increases an outer diameter of the adapter in the second direction in sections and can form an undercut with the outer diameter that is decreased in sections.

In accordance with embodiments, at least one of the inner or outer locking structures may be formed by a circumferential projection.

In other embodiments, the inner surface may include a first region having a first inner diameter and a second region having a second inner diameter that is smaller relative to the first region.

According to other embodiments, the adapter may be composed of a metal or a plastic having a Shore D hardness (according to DIN EN ISO 868) of greater than 75. Further, the adapter can be composed of a metal or a plastic having a Shore D hardness (according to DIN EN ISO 868) of between 80 and 90.

In embodiments, a fluid dispensing device includes an upper part, which include at least one second sleeve; and a lower part, which includes at least one first sleeve, the lower part being connectable to the upper part; and an adapter as defined above. The second sleeve of the upper part is connected to the first sleeve of the lower part via the adapter, and the adapter is respectively connected to the second sleeve of the upper part and the first sleeve of the lower part at least one of in a form fit or by a press fit.

In accordance with embodiments of the fluid dispensing device, the first sleeve of the lower part can be composed of a material having a Shore D hardness (according to DIN EN ISO 868) of less than 75. Further, the first sleeve of the lower part may be composed of a material having a Shore D hardness (according to DIN EN ISO 868) of between 45 and 70.

According to other embodiments of the fluid dispensing device, the second sleeve of the upper part may include at least one of a retaining groove or a projection protruding radially inwards which, with the undercut of the outer locking mechanism, form a snap-lock connection.

In still other embodiments of the fluid dispensing device, the second sleeve of the upper part, the first sleeve of the lower part, and the adapter can be designed and matched to one another such that a first assembly force, which is required for inserting the adapter into the second sleeve of the upper part, is greater than a second assembly force, which is required for fitting the adapter onto the first sleeve of the lower part, and that a first disassembly force, which is required for pulling the adapter out of the first sleeve of the upper part, is less than a second disassembly force, which is required for pulling the adapter off the sleeve of the lower part.

In embodiments, a method for assembling a fluid dispensing device define above includes inserting the adapter into the first sleeve of the upper part, and then inserting the first sleeve of the lower part into the adapter.

Embodiments are directed to a fluid dispensing device that includes an adapter; an upper part, which comprises at least one head sleeve; and a lower part, which comprises at least one cone sleeve, the lower part being connectable to the upper part. The head sleeve is connectable to the cone sleeve via the adapter, and the adapter is respectively connected to the head sleeve and the cone sleeve via at least one of a form fit connection or a press fit connection.

According to embodiments, the adapter may include an inner locking structure for connecting to the cone sleeve and an outer locking structure for connecting to the head sleeve.

In accordance with still yet other embodiments, the adapter can have an outer surface insertable into the head sleeve and an inner surface configured to receive the cone sleeve.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1A illustrates an adapter according to a first embodiment of the invention, in perspective view;

FIG. 1B illustrates a view of the adapter according to FIG. 1A, from below;

FIG. 1C illustrates a side view of the adapter according to FIG. 1A;

FIG. 1D illustrates a sectional view along the line A-A in FIG. 1C of the adapter according to FIG. 1A;

FIG. 2A illustrates a fluid dispensing device according to an embodiment of the invention after assembly, in sectional view;

FIG. 2B illustrates the fluid dispensing device according to FIG. 2A with a displaced adapter, in sectional view;

FIG. 2C illustrates the lower part of the fluid dispensing device according to FIG. 2A, in sectional view;

FIG. 2D illustrates the lower part of the fluid dispensing device according to FIG. 2A with a displaced adapter, in sectional view;

FIG. 3A illustrates an adapter according to a further embodiment of the invention, in perspective view;

FIG. 3B illustrates a view of the adapter according to FIG. 3A, from below;

FIG. 3C illustrates a side view of the adapter according to FIG. 3A; and

FIG. 3D illustrates a side view along the line A-A in FIG. 3C of the adapter according to FIG. 3A.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

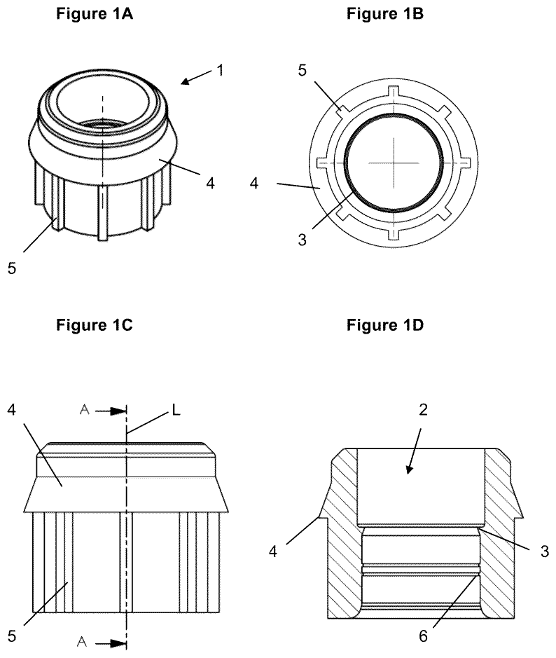

The adapter 1 illustrated in FIGS. 1A through 1D comprises an essentially cylindrical base body which encloses a central through opening 2 along a longitudinal axis L. The adapter 1 is composed of a relatively hard plastic, for example polyoxymethylene (POM) having a Shore D hardness (according to DIN EN ISO 868) of approximately 83.

The inner surface of the adapter 1, which surrounds the through opening 2, is in the embodiment shown provided with a projection 3, protruding radially inwards, which forms an inner locking structure for fixing the adapter 1 on a component that is not depicted. The projection 3 comprises a lower insertion bevel in FIG. 1D and forms an undercut on the upper side thereof in FIG. 1D. In this manner, the adapter 1 can be moved on a sleeve-shaped component not illustrated in FIGS. 1A through 1D with less resistance downwards than in the reverse direction. The region of the adapter 1 located above the projection 3 in FIG. 1D has a larger inner diameter than the region located below the projection 3.

In a similar manner, the outer surface of the adapter 1 is provided with a projection 4, protruding radially outwards, which forms an outer locking structure for fixing the adapter 1 in a component not shown. The projection 4 comprises an upper insertion bevel in FIG. 1D and forms an undercut on the lower side thereof in FIG. 1D. In this manner, the adapter 1 can be moved into a sleeve-shaped component not illustrated in FIGS. 1A through 1D with less resistance upwards than in the reverse direction.

In the exemplary embodiment shown, additional inner and outer locking structures are provided, which are envisaged as ribs 5 that are provided parallel to the longitudinal axis L on the outer surface of the adapter 1 such that they are distributed about the circumference at regular intervals, and as circumferential beads 6 projecting radially inwards from the inner surface. The ribs 5 can thereby also serve as a supporting structure/stabilization for the large diameter offset, and/or the beads 6 can be used for sealing purposes. Furthermore, it is possible to choose the surface roughness of the inner surface and/or the outer surface such that a high clamping force can be obtained between the adapter 1 and the component(s) that can be connected thereto.

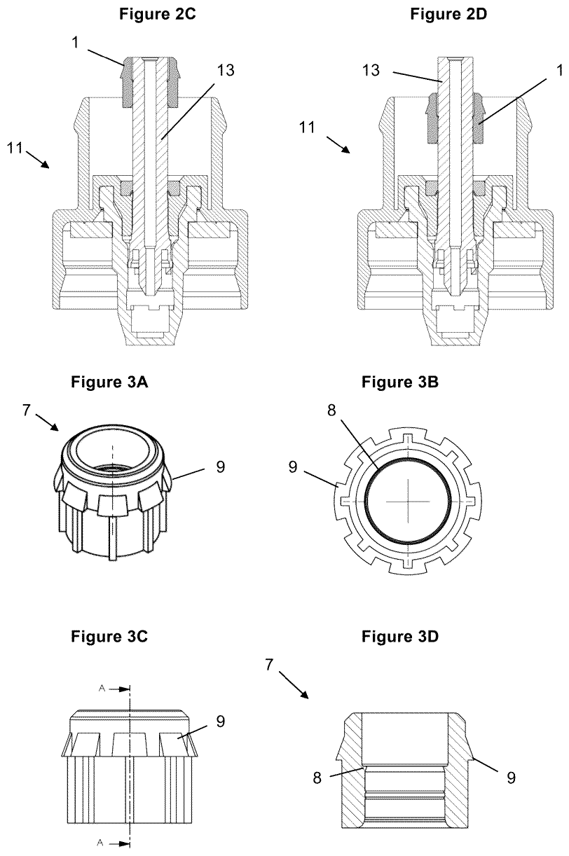

A further exemplary embodiment of an adapter 7 according to the invention is illustrated in FIGS. 3A through 3D. In terms of basic construction, the embodiment according to FIGS. 3A through 3D corresponds to the first embodiment illustrated in FIGS. 1A through 1D, with a base body that surrounds a through opening and comprises an inner projection 8 as an inner locking structure. An outer locking structure is formed by a plurality of wedge-shaped projections 9 which are arranged on the outer surface of the adapter 7 such that they are distributed uniformly about the circumference.

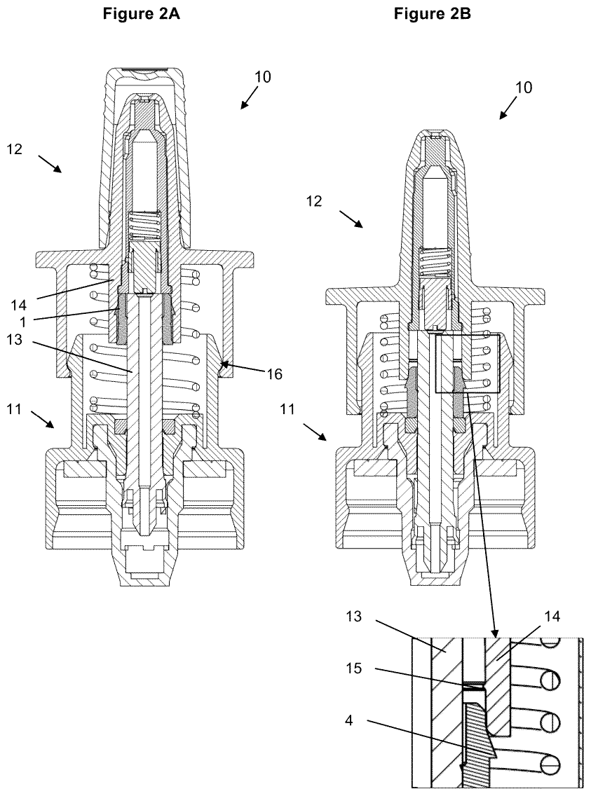

In FIGS. 2A and 2B, a fluid dispensing device 10 is shown in two different states. The fluid dispensing device 10 comprises, for example, an adapter 1 of the type described above, as well as a lower part 11 illustrated in FIGS. 2A-2D and an upper part 12 shown only in FIGS. 2A and 2B for the sake of clarity. The lower part 11 can be connected to a container, not shown, in which a fluid that can be discharged by the fluid dispensing device 10 is contained.

The lower part 11 comprises, among other things, a sleeve 13 which can in part also be referred to as the cone of a pump. The upper part 12 is likewise provided with a sleeve 14, which can be part of the head of a pump. The sleeves 13 and 14 can be composed of a plastic that is softer as compared to the adapter 1, for example polypropylene (PP) or polyethylene (PE).

The adapter 1 connects the sleeve 13 to the sleeve 14, and therefore the lower part 11 to the upper part 12 of the fluid dispensing device 10. For this purpose, in the state shown in FIG. 2A, the adapter 1 is first inserted into the sleeve 14 of the upper part 12 until the outer projection 4 engages behind a retaining groove 15 in the sleeve 14. Instead of a snap-lock connection of this type, or in addition thereto, the outer surface of the adapter 1 can be pressed into the sleeve 14. The adapter 1 accommodated in the sleeve 14 is then fitted onto the sleeve 13 of the lower part 11, whereby the projection 3 of the adapter 1 is embedded into the sleeve 13.

The adapter 1 is thereby matched to the sleeves 13 and 14 such that a force F1 for assembling the adapter 1 in the sleeve 14 is greater than a force F2 for assembling the adapter 1 on the sleeve 13. Additionally, the adapter 1 and the sleeves 13 and 14 are matched to one another such that a force F3 for disassembling the adapter 1 from the sleeve 14 is less than a force F4 for disassembling the adapter 1 from the sleeve 13. This can occur, for example, using the sizing of the projections 3 and 4, by selecting suitable diameters of the base body of the adapter 1, and/or by selecting suitable surface roughnesses.

This results, in the event of an attempt to pull the upper part 12 off the lower part 11 in the state of the fluid dispensing device 10 shown in FIG. 2A, in the initial necessity of extremely high forces, which in most cases can prevent such a detachment of the upper part 12. If the forces applied to detach the upper part 12 exceed the force F3, the connection between the adapter 1 and the sleeve 14 fails in a defined manner, whereas the adapter 1 remains connected to the sleeve 13. If an attempt is then made to once again connect the upper part 12 to the lower part 11, the comparatively lower force F2 for assembling the adapter 1 on the sleeve 13 causes the adapter 1 to be displaced downwards on the sleeve 13 in FIG. 2B, without the adapter 1 connecting to the sleeve 14. The lower part 11 and the upper part 12 are therefore not reconnected to one another via the adapter 1, and a tampering by removal of the upper part 12 from the lower part 11 is easily discernible for a user.

The relative movement between the upper part 12 and the lower part 11 can, as shown in FIG. 2B, be limited if the upper end of the sleeve 13 in FIG. 2B strikes a projection in the sleeve 14, or a component inserted into said sleeve 14.

Regardless of the firm connection between the upper part 12 and the lower part 11 via the adapter 1, the fluid dispensing device 10 can comprise a further snap-lock connection 16 between a component of the upper part 12 and a component of the lower part 11. Aside from an additional protection against inadvertent removal of the upper part 12, said snap-lock connection 16 primarily serves to protect the inner components of the fluid dispensing device 10 against the ingress of debris and the like.

The functioning of the adapter 1 and 7 according to the invention, as well as the advantages associated therewith, are once again summarized in the following: Embodiments seek to render the disassembly of a fluid dispensing device 10 more difficult. In order to enable a very high retaining strength between the upper and lower parts 11, 12, the adapter 1 and 7 is specially designed and constructed. It comprises two very strong undercuts which are formed by the inner and outer locking structure of the projections 3, 4. Said projections 3, 4 become wedged with the respective counterpart thereof, that is, the sleeves 13, 14, in the disassembly direction. In the assembly direction, they have an insertion bevel in order to further enable easy assembly.

The inner locking mechanism of the projection 3 embeds itself deep into what is referred to as the cone, that is, the sleeve 13. The connection is so strong that it can no longer be separated even using pliers. This is also achieved by the materials. The adapter 1 is composed of a hard plastic (for example, POM), whereas the cone (sleeve 13) is made of a softer plastic.

In the head of the fluid dispensing device 10, that is, the sleeve 14, which forms the counterpart to the outer locking mechanism of the projection 4 of the adapter 1, the retaining groove 15 is formed on the inner diameter, behind which retaining groove 15 the outer locking mechanism of the projection 4 engages and thus enables a high retaining strength. The head is, for example, made of a harder material than the cone, and the locking mechanism does not embed itself into the head to the same extent as in the cone. As a result, a disassembly is rendered significantly more difficult, but not impossible. This facilitates the tamper protection and the furnishing of proof that a system has been tampered with.

In the production of the fluid dispensing device 10, the adapter 1 is inserted into the upper part 12 (head) in the first step. In the second step, the lower part 11 is assembled to the upper part 12, including the adapter 1. Through the insertions of the single-sided locking mechanisms, all components can be easily assembled to one another, but are difficult to disassemble.

If the disassembly force F3 of the adapter 1 from the upper part 12 is less than the disassembly force F4 of the adapter 1 from the lower part 11, this results in the adapter 1 always being pulled out of the upper part 12 and remaining attached to the lower part 11 during disassembly. The disassembly force F4 is thereby preferably great enough that it is not possible, even with pliers, to pull the adapter off without damaging the entire lower part in the process. Additionally, if the assembly force F1 of the adapter 1 to the upper part 12 is greater than the assembly force F2 of the adapter 1 to the lower part 11, this results in the adapter 1 sliding downwards on the cone of the lower part 11 during an attempt to reconnect the pump. It is thus no longer possible to insert the adapter 1 into the head of the upper part 12. Therefore, the lower part 11 can no longer be connected to the upper part 12. Once disassembled, it is thus no longer possible to reassemble the lower and upper parts 11, 12.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### REFERENCE NUMERALS

1 Adapter
2 Through opening
3 Projection (inner locking structure)
4 Projection (outer locking structure)
5 Rib
6 Bead
7 Adapter
8 Projection (inner locking structure)
9 Projection (outer locking structure)
10 Fluid dispensing device
11 Lower part
12 Upper part
13 Sleeve (cone; first)
14 Sleeve (head; second)
15 Retaining groove
16 Snap-lock connection
L Longitudinal axis

What is claimed:

1. An adapter for connecting a second sleeve of an upper part and a first sleeve of a lower part of a fluid dispensing device, the adapter comprising:
a ring-shaped base body with:
a longitudinal axis;
an inner surface, which encloses a through opening for accommodating the first sleeve and includes an inner locking structure; and
an outer surface, which is insertable into an opening of the second sleeve and includes an outer locking structure,
wherein at least one of the locking structures is designed such that when the adapter is connected to one of the first or second sleeve, resistance to a relative movement of the adapter to the one of the first or second sleeve in a first direction along the longitudinal axis is greater than in a second direction opposed to the first direction.

2. The adapter according to claim 1, wherein the inner locking structure comprises at least one projection, which protrudes radially inwards from the inner surface and has an insertion bevel that decreases an inner diameter of the adapter in the first direction in sections and forms an undercut with an inner diameter that is increased in sections.

3. The adapter according to claim 1, wherein the outer locking structure comprises at least one projection, which protrudes radially outwards from the outer surface and has an insertion bevel that increases an outer diameter of the adapter in the second direction in sections and forms an undercut with the outer diameter that is decreased in sections.

4. The adapter according to claim 1, wherein at least one of the inner or outer locking structures is formed by a circumferential projection.

5. The adapter according to claim 1, wherein the inner surface comprises a first region having a first inner diameter and a second region having a second inner diameter that is smaller relative to the first region.

6. The adapter according to claim 1, wherein the adapter is composed of a metal or a plastic having a Shore D hardness (according to DIN EN ISO 868) of greater than 75.

7. The adapter according to claim 6, wherein the adapter is composed of a metal or a plastic having a Shore D hardness (according to DIN EN ISO 868) of between 80 and 90.

8. A fluid dispensing device comprising:
an upper part, which comprises at least one second sleeve;
a lower part, which comprises at least one first sleeve, the lower part being connectable to the upper part; and
an adapter according to claim 1,
wherein the second sleeve of the upper part is connected to the first sleeve of the lower part via the adapter, and
wherein the adapter is respectively connected to the second sleeve of the upper part and the first sleeve of the lower part at least one of in a form fit or by a press fit.

9. The fluid dispensing device according to claim 8, wherein the first sleeve of the lower part is composed of a material having a Shore D hardness (according to DIN EN ISO 868) of less than 75.

10. The fluid dispensing device according to claim 9, wherein the first sleeve of the lower part is composed of a material having a Shore D hardness (according to DIN EN ISO 868) of between 45 and 70.

11. The fluid dispensing device according to claim 8, wherein the second sleeve of the upper part comprises at least one of a retaining groove or a projection protruding radially inwards which, with the undercut of the outer locking mechanism, form a snap-lock connection.

12. The fluid dispensing device according to claim 8, wherein the second sleeve of the upper part, the first sleeve of the lower part, and the adapter are designed and matched to one another such that a first assembly force, which is required for inserting the adapter into the second sleeve of the upper part, is greater than a second assembly force, which is required for fitting the adapter onto the first sleeve of the lower part, and that a first disassembly force, which is required for pulling the adapter out of the first sleeve of the upper part, is less than a second disassembly force, which is required for pulling the adapter off the sleeve of the lower part.

13. A method for assembling a fluid dispensing device according to claim 8, comprising:
inserting the adapter into the first sleeve of the upper part,
then inserting the first sleeve of the lower part into the adapter.

14. A fluid dispensing device comprising:
an adapter;
an upper part, which comprises at least one head sleeve; and
a lower part, which comprises at least one cone sleeve, the lower part being connectable to the upper part;
wherein the head sleeve is connectable to the cone sleeve via the adapter, and
wherein the adapter is respectively connected to the head sleeve and the cone sleeve via at least one of a form fit connection or a press fit connection.

15. The fluid dispensing device according to claim 14, wherein the adapter includes an inner locking structure for connecting to the cone sleeve and an outer locking structure for connecting to the head sleeve.

16. The fluid dispensing device according to claim 14, wherein the adapter has an outer surface insertable into the head sleeve and an inner surface configured to receive the cone sleeve.
